(19) United States
(12) Patent Application Publication
(10) Pub. No.: US 2007/0267772 A1
(43) Pub. Date: Nov. 22, 2007

(54) Process for the production of foamed plastic bodies

(76) Inventors: Michael Fischer, Linz (AT); Mark Voelkel, Ladenburg (DE)

Correspondence Address: NOTARO AND MICHALOS, 100 DUTCH HILL ROAD, SUITE 110, ORANGEBURG, NY, 10962-2100, US

(21) Appl. No.: 11/747,951

(22) Filed: May 14, 2007

(30) Foreign Application Priority Data
May 16, 2006 (AT) GM 392/2006

(51) Int. Cl. B29C 44/34

(52) U.S. Cl. 264/50; 264/51; 264/85

(57) ABSTRACT

A process for the production of foamed plastic bodies, including the steps:
introducing a physical foaming agent into the plasticised plastic material which is in the plasticising unit and which is to be foamed, wherein the physical foaming agent is introduced into the plasticised plastic material at a pressure of more than 180 bars, preferably more than 300 bars, particularly preferably more than 350 bars,
injecting the plastic material provided with physical foaming agent into the tool cavity of the injection moulding machine, and
decompression of the molten plastic material by expansion of the tool cavity.

The invention concerns a process for the production of foamed plastic bodies.

The instrument panels of current motor cars often have an instrument panel with a surface of a leather appearance and a plastic foam which is disposed therebehind and which makes a connection to a carrier. Composite bodies of such a nature are produced by foam-backing of slush-moulded covering skins, with polyurethane which in that case also produces the bond to the preferably injection-moulded carrier. DE 43 04 751 C2 discloses plastic parts in which a molten material mixed with foaming agent gas is applied to an injection-moulded carrier, the molten material then being foamed by subsequent decompression. The processes described therein use foaming agents which under the influence of heat or catalysts give off inter alia CO₂ or N₂ and thus foam up the plastic material by virtue of the foaming pressure resulting therefrom. It will be noted however that the plastic parts produced in that way are not ideal in terms of their surface and touch property. The bulk densities of the plastic material, the softness achieved therewith and the soft touch effect resulting therefrom were too slight. In addition only injection moulding of the plastic material is possible as otherwise the bonding seam stands out.

Besides the chemical foaming agents disclosed in DE 43 04 751 C2, foamed plastic materials are also known, which are foamed by means of physical foaming agents. It will be noted however that the plastic materials produced in accordance with the previous processes and foamed by means of physical foaming agents have extremely unsightly surfaces. Therefore such plastic materials cannot be used for components in the visible region. The previous processes in addition produce foams which are of a very large-cell nature and which do not have the desired soft touch effect. That is to be attributed to the large cell with gas inclusion, with the cell having a relatively stiff wall at the same time.

Therefore the object of the present invention is to develop a process for foaming plastic materials in such a way that on the one hand they are distinguished by optically attractive surfaces and can thus be used without concealment and that on the other hand they have a pleasant touch, that is to say a so-called soft touch effect (for example: as in the case of leather).

According to the invention that is achieved by a process for the production of foamed plastic bodies, characterised by the steps:
introducing a physical foaming agent into the plasticised plastic material which is in the plasticising unit and which is to be foamed, wherein the physical foaming agent is introduced into the plasticised plastic material at a pressure of more than 180 bars, preferably more than 300 bars, particularly preferably more than 350 bars,
injecting the plastic material provided with physical foaming agent into the tool cavity of the injection moulding machine, and
decompression of the molten plastic material by expansion of be tool cavity.

The surprising effect according to the invention was exhibited when a physical foaming agent is introduced into the molten plastic material under a particularly high pressure. While in the case of the previously known foaming operation with physical foaming agents pressures in the region of far below 200 bars were used, it was possible to achieve the optimum effect according to the invention by the increase in pressure according to the invention and the consequential steps. Ideally the pressure is above 200 bars. The effect was particularly pronounced at a pressure level of 350 bars or more. In that respect the term physical foaming agent is used to denote a foaming agent which is not produced in the interior of the molten material by a chemical process, for example by a gaseous molecule being separated off. Therefore that expression is rather used to denote foaming agents which are introduced in gas form into the plastic material such as for example nitrogen, CO₂, noble gas and so forth.

In the simplest variant it is conceivable for the molten plastic material also to be injected into the tool cavity at a pressure of over 200 bars, preferably more than 300 bars, particularly preferably more than 350 bars. It will be noted however that particularly attractive surfaces could be achieved when, after the physical foaming agent was introduced into the molten plastic material but prior to injection of the molten plastic material into the tool cavity, an intermediate decompression step is effected. Such an intermediate decompression step, that is to say a corresponding reduction in pressure in the molten plastic material, can be achieved for example by the nozzle application force being reduced or, in the case of a plasticising unit in screw form, by a reduction in the screw. It is also possible to open a needle closure nozzle in the hot runner. Initial results showed that a pressure reduction to 70 to 80 bars gave very attractive results. It will be noted that it then was found to be desirable if, after the intermediate decompression step, the pressure in the molten plastic material is increased. In that case it is possible for the pressure to be again raised to the above-mentioned pressure level.

Although generally the desired plastic bodies having the above-mentioned properties can be achieved with the process it may nonetheless be advantageous ff the plastic body has regions which are of a higher strength, for example for fixing an instrument panel to the motor car. Therefore, in a variant, it can be provided the foamed plastic body is applied to a carrier by the carrier being introduced into the tool cavity of the injection moulding machine prior to injection of the plastic material. In that respect the carrier can itself be a plastic body which for example is previously fitted into the tool cavity of the injection moulding machine. It would however also be conceivable for the carrier to be produced in the injection moulding machine itself and for the process according to the invention to then be applied by suitable adaptation of the tool cavity. Expansion can be effected by a specifically implemented stroke in the tool or in respect of the closing force. The molten material can involve so much pressure that it promotes the opening movement by the foam pressure. Advantageous results are achieved for example using an embossing tool. In that respect, conversely to the injection embossing process, a cavity is provided in the tool, in which the molten plastic material is injected. Then the closing unit is displaced in a specifically targeted fashion by a suitable stroke so that the cavity is correspondingly enlarged. It will be appreciated that expansion can also be effected in per se known manner in other ways.

The effect according to the invention could be achieved particularly well if the foamed plastic body is a thermoplastic elastomer, preferably on a polyester basis or based on PBT.

By virtue of the fact that high pressures and temperatures occur in the process steps mentioned, it is desirable if the foaming agent is an inert gas, preferably nitrogen, carbon dioxide or mixtures thereof. In that respect the term inert gas is used to mean that this is gases which do not chemically react in a (negative) fashion with the molten plastic material.

In the final effect the amount of foaming agent added also depends on the desired properties for the plastic body. In a variant the ideal range is in an amount of 0.3% to 4%, preferably 0.7% (in each case in percent by weight). In the ideal case the amount of foaming agent will also be matched to the expansion volume of the tool cavity. Advantageous values are achieved in particular when the volume of the tool cavity upon expansion is increased to 1.5 to 4 times, preferably to about 2.5 times. The bulk densities of the foamed plastic material or polymer, which can thus ultimately be achieved, are at about 60% of the gross density or below. The process of that kind could be implemented for example by a procedure whereby the carrier has in region wise manner a spacing relative to the inside wall of the tool cavity of 1 to 3 mm, preferably 2 mm. In a desirable variant it has been found that it is advantageous ff the injection speed of the plasticised plastic material into the tool cavity is between 10 mm/sec and 200 mm/sec, preferably 60 mm/sec, and the tool cavity is enlarged during the decompression operation at a decompression speed of between 1 mm/sec and 25 mm/sec. Those values have proven to be advantageous in particular when using an injection embossing tool, wherein the decompression speed means the movement of the movable mould mounting plate of the injection moulding machine in the direction of movement.

The decompression speed has a crucial influence on the foamed plastic material and therefore it may be desirable if the decompression speed is multi-stage, that is to say there is firstly a faster expansion and then a slower expansion or vice-versa. It may also prove to be advantageous if, between the injection operation having been effected and the subsequent expansion operation, the tool cavity is held in its shape for a period of time of up to 10 secs, preferably about 1 sec.

Optimum surfaces in respect of the foamed plastic body could be achieved for example when the tool cavity has sintered metal inserts. The results would be even better if the sintered metal inserts are subjected at times to the action of vacuum. If plastic bodies with a smooth surface are to be produced, it is advantageous if the wall of the tool cavity has a smooth surface. As it will be appreciated that in many regions there is a wish to achieve the optical effect of a leather surface or at least an attractive structured surface, it is provided in most cases that the wall of the tool cavity has at least region-wise a leather engraving surface or is provided with symbols or characters.

Optimum control of foaming of the plastic material in respect of which the injected plastic material is mixed with foaming agent is possible when prior to the injection operation the tool cavity is put under pressure, preferably with the physical foaming agent. During the injection operation the previously introduced gas can then be let out of or escape from the tool cavity in a controlled and specifically implemented fashion. After the expansion step has been implemented and after the foaming that this entails the tool cavity can be cooled from the exterior so that the plastic body can be ideally removed after removal from the mould.

1. A process for the production of foamed plastic bodies, comprising the steps:
introducing a physical foaming agent into the plasticised plastic material which is in the plasticising unit of an injection moulding machine and which is to be foamed, wherein the physical foaming agent is introduced into the plasticised plastic material at a pressure of more than 180 bars,
injecting the plastic material provided with physical foaming agent into the tool cavity of said injection moulding machine, and
decompression of the molten plastic material by expansion of the tool cavity.

2. A process according to claim 1, wherein the pressure is more than 300 bars.

3. A process according to claim 1, wherein the pressure is more than 350 bars.

4. A process according to claim 1, wherein an intermediate decompression step is effected after introduction of the physical foaming agent into the molten plastic material but prior to injection of the molten plastic material into the tool cavity.

5. A process according to claim 4, wherein after the intermediate decompression step the pressure in the molten plastic material is increased.

6. A process according to claims 1, wherein the foamed plastic body is applied to a carrier by the carrier being introduced into the tool cavity of the injection moulding machine prior to injection of the plastic material.

7. A process according to claim 1, wherein the foamed plastic body is a thermoplastic elastomer.

8. A process according to claim 7, wherein the thermoplastic elastomer is on a polyester basis.

9. A process according to claim 7, wherein the thermoplastic elastomer comprises PBT.

10. A process according to claim 1, wherein the foaming agent is an inert gas.

11. A process according to claim 10, wherein the inert gas is selected from the group nitrogen, carbon dioxide or mixtures thereof.

12. A process according to claim 1, wherein the foaming agent is present in an amount of 0.3% to 4% (percent by weight.

13. A process according to claim 12, wherein the foaming agent is present in an amount of 0.7%.

14. A process according to claim 6, wherein the carrier has in region-wise manner a spacing relative to the inside wall of the tool cavity of 1 to 3 mm.

15. A process according to claim 14, wherein the carrier has in region-wise manner a spacing relative to the inside wall of the tool cavity of 2 mm.

16. A process according to claim 1, wherein the volume of the tool cavity upon expansion is increased to 1.5 to 4 times.

17. A process according to claim 16, wherein the volume of the tool cavity upon expansion is increased to about 2.5 times.

18. A process according to claim 1, wherein the injection speed of the plasticised plastic material into the tool cavity is between 10 mm/sec and 200 mm/sec.

19. A process according to claim 18, wherein the injection speed of the plasticised plastic material into the tool cavity is about 60 mm/sec.

20. A process according to claim 1, wherein the tool cavity is enlarged during the decompression operation at a decompression speed of between 1 mm/sec and 25 mm/sec.

21. A process according to claim 20, wherein the decompression speed is multi-stage.

22. A process according to claim 1, wherein between the injection operation effected and decompression, there is a period of time of 0 to 10 seconds.

23. A process according to claim 22, wherein between the injection operation effected and decompression, said period of time is about 1 second.

24. A process according to claim 1, wherein the tool cavity has sintered metal inserts.

25. A process according to claim 24, wherein the sintered metal inserts are subjected at times to the action of vacuum.

26. A process according to claim 1, wherein the wall of the tool cavity has at least region-wise a smooth surface.

27. A process according to claim 1, wherein the wall of the tool cavity has at least region-wise a leather engraving surface or is provided with symbols or characters.

28. A process according to claim 1, wherein prior to the injection operation the tool cavity is put under pressure.

29. A process according to claim 28, wherein prior to the injection operation the tool cavity is put under pressure with said physical foaming agent.
